(19) United States
(12) Patent Application Publication
(10) Pub. No.: US 2017/0354862 A1
(43) Pub. Date: Dec. 14, 2017

(54) Fitfreak - Board Game - Lessons on Fitness, in a game

(71) Applicant: Basanth Lalchand, Jersey City, NJ (US)

(72) Inventor: Basanth Lalchand, Jersey City, NJ (US)

(21) Appl. No.: 15/180,006

(22) Filed: Jun. 11, 2016

(51) Int. Cl. A63F 3/04; G09B 19/00; A63F 3/00

(52) U.S. Cl. CPC A63F 3/0478; A63F 3/00006; G09B 19/0092; G09B 19/00; G09B 19/0084; G09B 19/003; A63F 2003/00018; A63F 2003/00996

(57) ABSTRACT

A board game and method of implementing the game comprise displaying a squared oblong rectangular game board comprising a width comprising at least ten squares. A set of player pawns or markers pieces on the game board is envisaged. The player pawns are initially arranged for beginning play by retention with the players themselves. Game play is enabled by one or more users following the standard set of rules.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

The earlier specification was not submitted per the required format. It only contained Figures which were marked as specifications. The new specification submitted herein is per the requisite format. It however does not contain any new matter whatsoever.

### BACKGROUND OF THE INVENTION

### (1) Field of the Invention

Fitfreak is based on the traditional board game model of rolling dice and moving forward the number specified on the dice. One or more embodiments of the invention generally relate to games. More particularly, the invention relates to a game based ors a board, very similar to the popular board game “Monopoly”.

### (2) DESCRIPTION OF RELATED ART INCLUDING INFORMATION DISCLOSED UNDER 37 CFR 1.97 AND 1.98

Not Applicable

### BRIEF SUMMARY OF THE INVENTION

Starting from the square marked “Start”—There are events and occurrences that occur when you land on a specific square on the board. The player moves forward the number of squares based on the dice rolled by him and the number shown thereon. These events and occurrences are explained in further detail based on the rules of the game. The core concept of the game is that you start at age Zero and move on till you reach the age of Hundred. As you move on the board, your health-related habits impact your movement on the game. The player may be moving sooner or faster depending on their health-related habits. Also based on the age, the player's health-related habits may or may not impact. Additionally, the severity of the impact depicted by penalties in the game is determined by your age. As an example, if you are smoking at age 20 it may not harm you as much as it may impact you at age 80. Essentially, bad habits make the players advance their age faster, making them exit the game faster. The player who finishes the game the last is the winner and the first is the loser. Another concept of the game is the player's ability to nullify the bad effects of bad habits by undertaking challenges or good habits. A related aspect of the game is that a player could be dead (read exits the game and loses) due to consistently extreme bad habits, all of a sudden.

### BRIEF DESCRIPTION OF THE FIGURE(S)

(1) FIG. 1—Board: The board contains all the squares, illustrations, images, markings and citations that will help the players place their pins/markers and navigate on the board by moving along the squares depicted on the board.

FIG. 1A—Bottom right quadrant of FIG. 1 to provide an enhanced and clearer view to the examiner.

FIG. 1B—Bottom left quadrant of FIG. 1 to provide an enhanced and clearer view to the examiner.

FIG. 1C—Top left right quadrant of FIG. 1 to provide an enhanced and clearer view to the examiner.

FIG. 1D—Top right quadrant of FIG. 1 to provide an enhanced and clearer view to the examiner.

(2) FIG. 2—Player Pawns: The player pawns that have been used in FIG. 2 are merely illustrative. The applicant does not intend to claim patents in any way or form on the same. The player pawns have been displayed to convey that they will be used as a part of the game. Player pawns are used based on their unique color or shape to associate with the identity of an individual player.

(3) FIG. 3—Dice: The dice that have been used in FIG. 3 are merely illustrative. The applicant does not intend to claim patents in any way or form on the same. The dice have been displayed to convey that they will be used as a part of the game.

(4) FIGS. 4, 5, 6, 7, 8 and 9—Harmful Habits Cards: These cards depicted in the Figure, are to be picked up by the players of the game upon the occurrence of a certain event. The event that will prompt the players to pick up these cards have been described later on as a part of the detailed description.

(5) FIGS. 10 and 11—Stay Young Cards: These cards depicted in the Figure, are to be picked up by the players of the game upon the occurrence of a certain event. The event that will prompt the players to pick up these cards have been described later on as a part of the detailed description.

(6) FIG. 12—Frontal View of Harmful Habit and Stay Young Cards: These cards depicted in the Figure, are to be picked up by the players of the game upon the occurrence of a certain event. This figure represents the frontal generic design of the card, merely indicating whether the card is a “Harmful Habit Card” or a “Stay Young Card”.

### DETAILED DESCRIPTION OF THE INVENTION

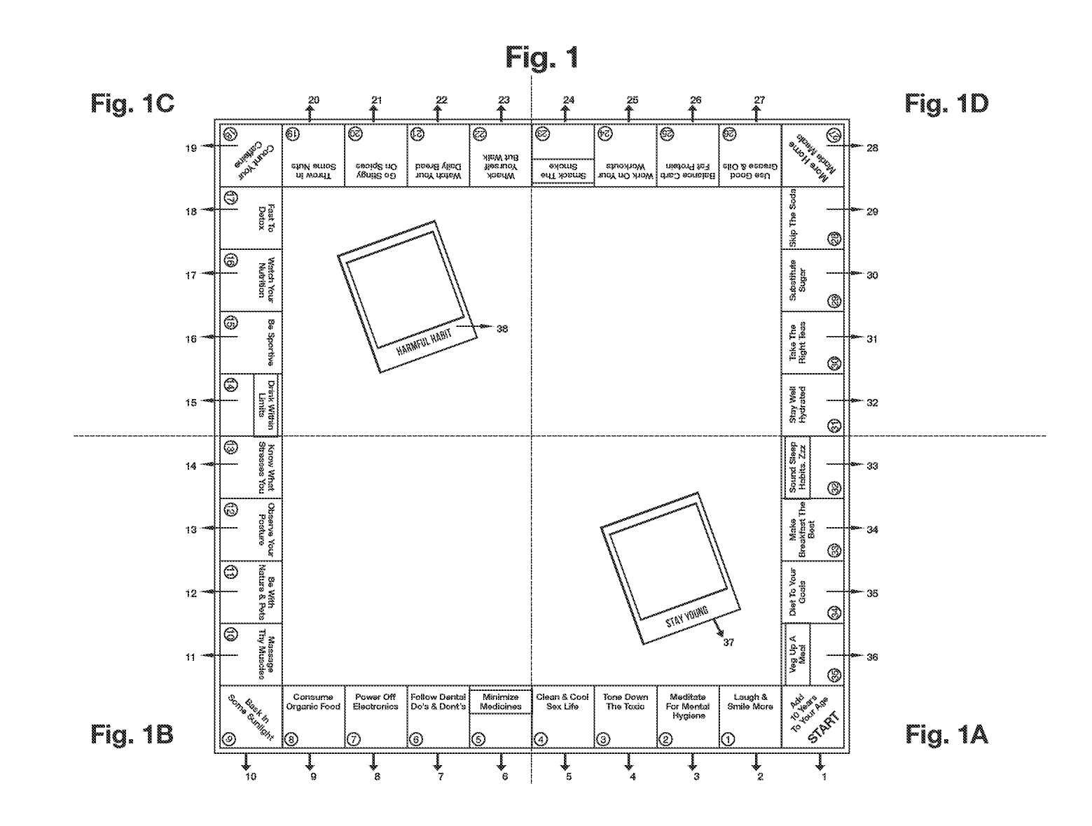

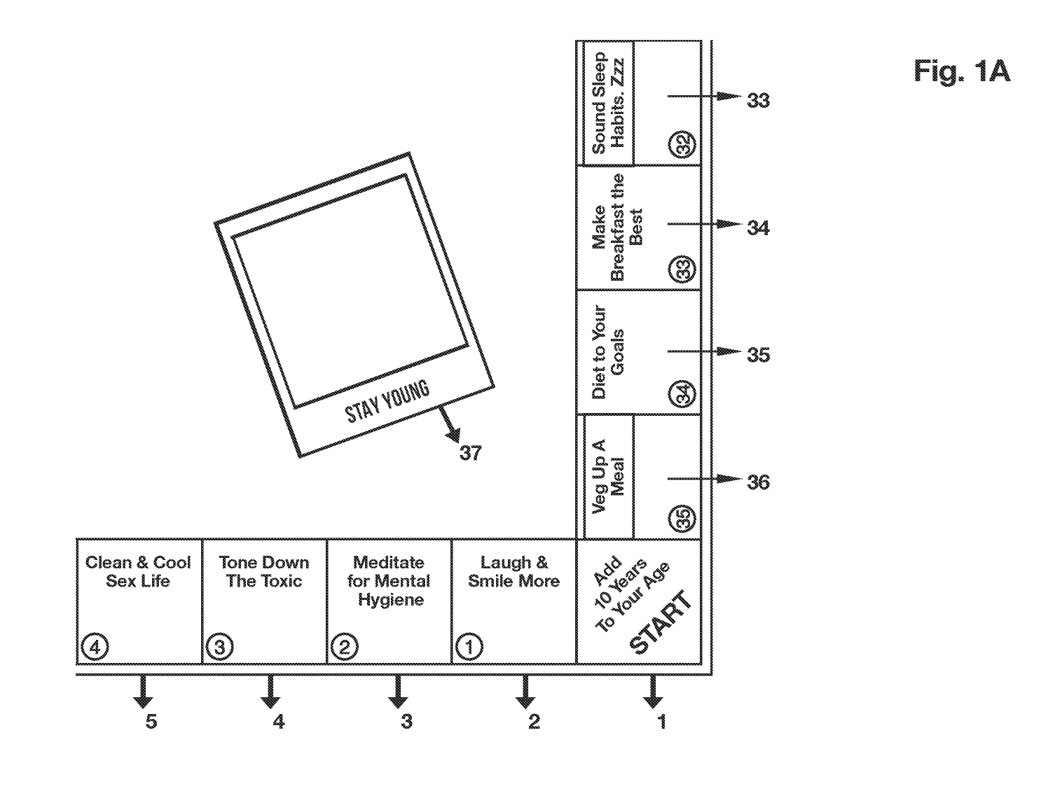

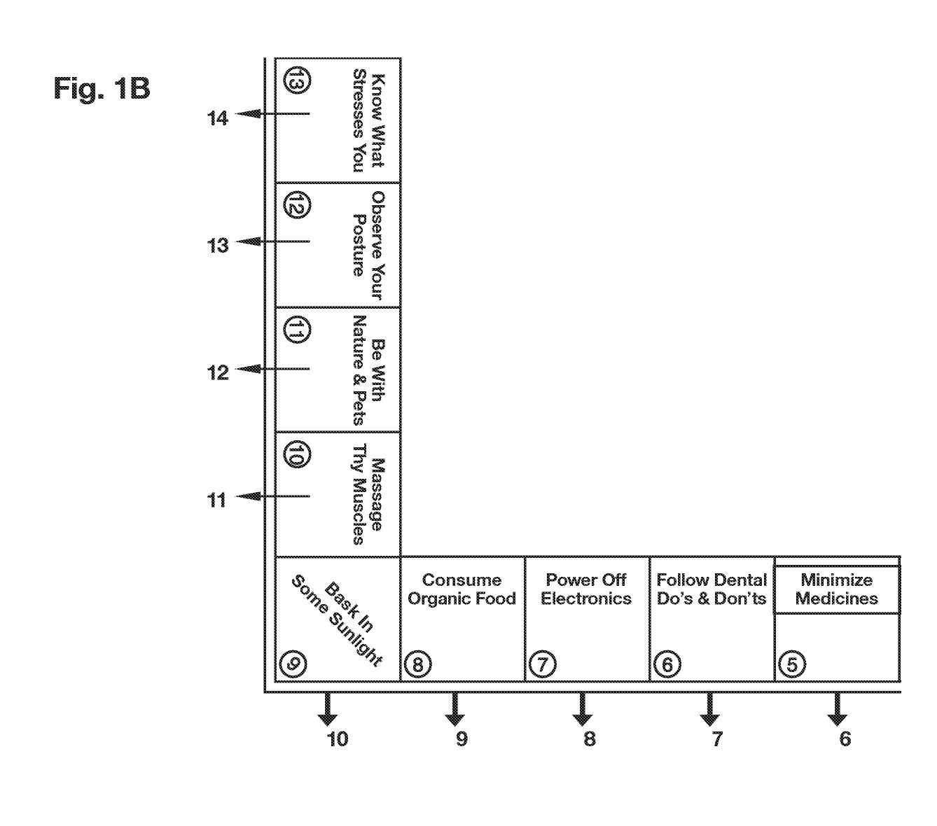

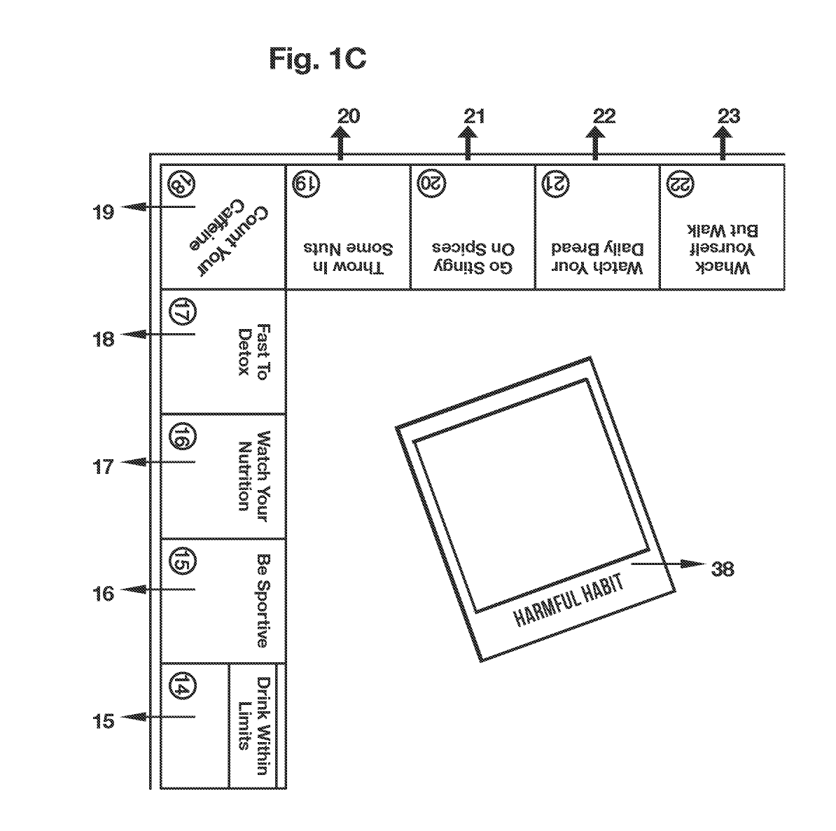

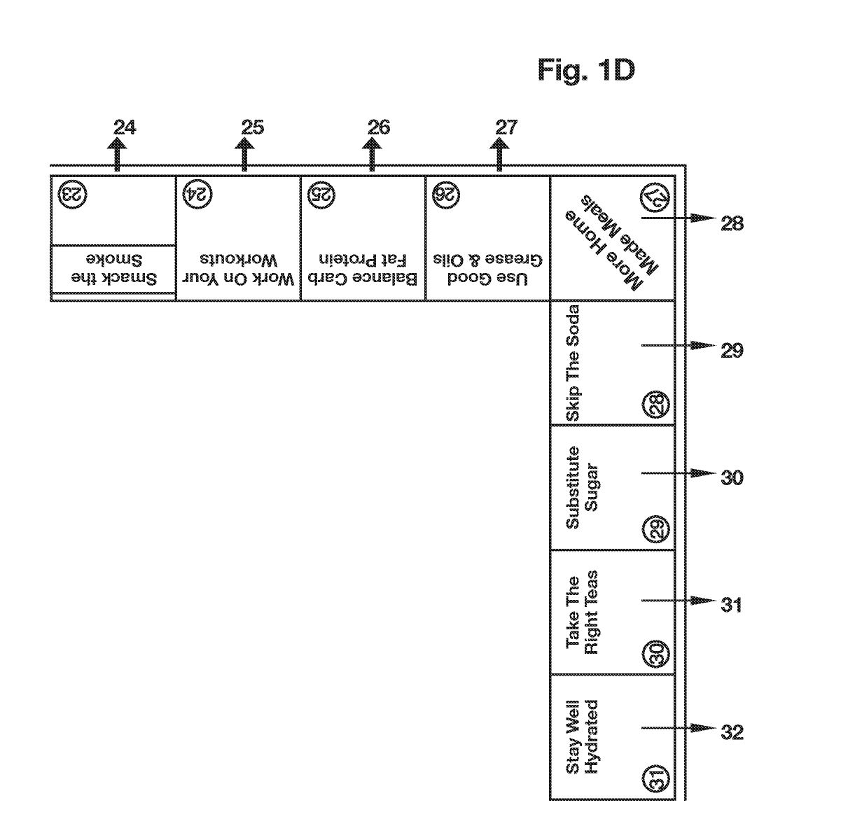

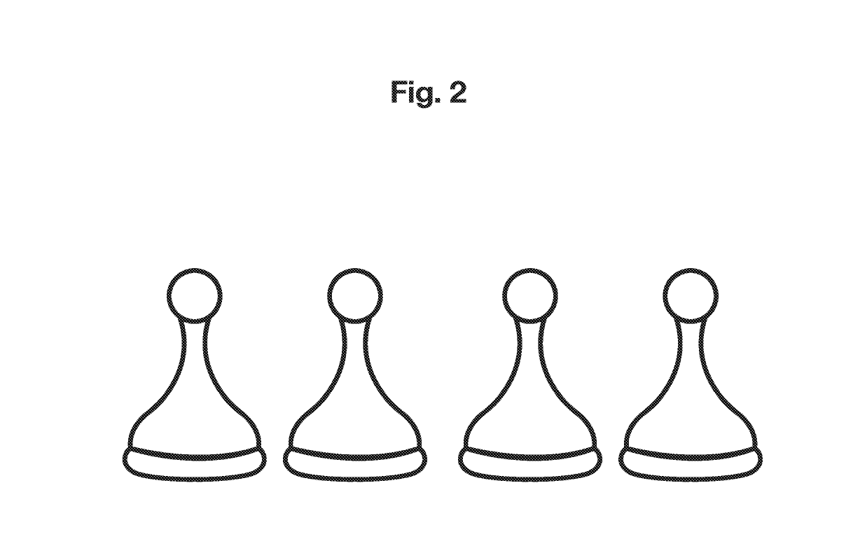

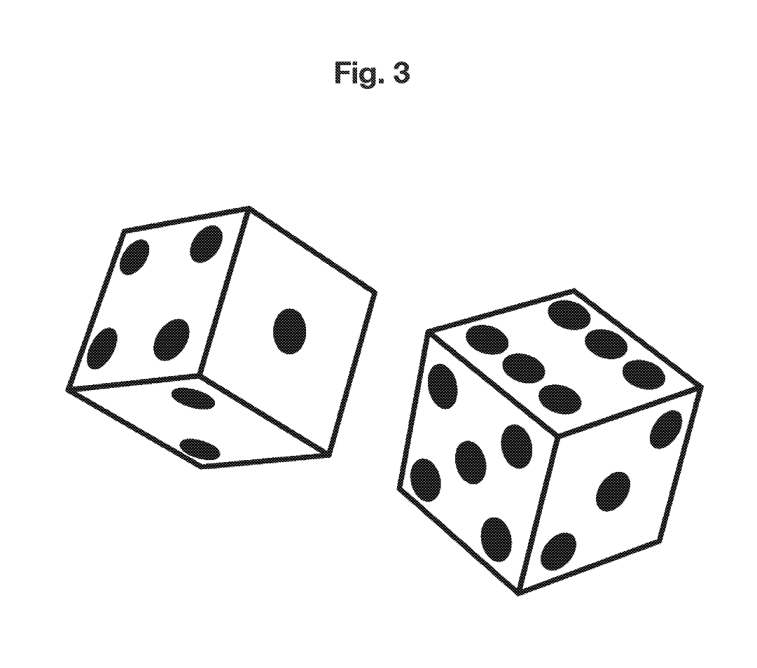

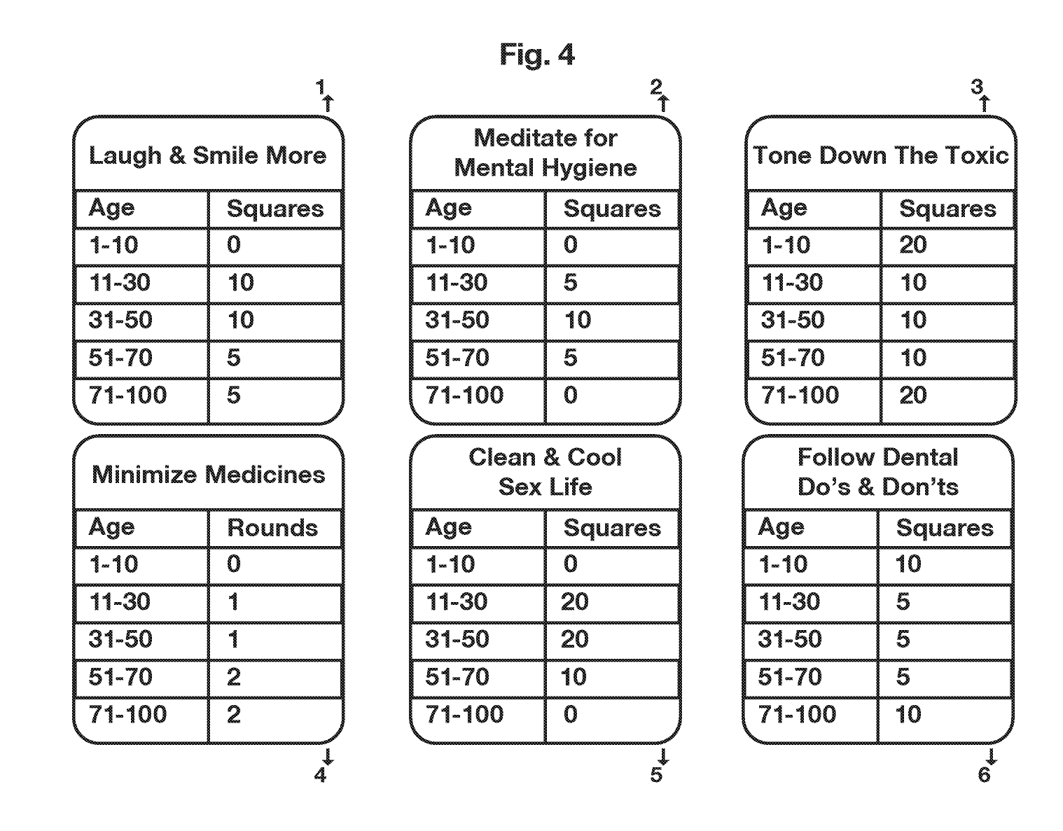

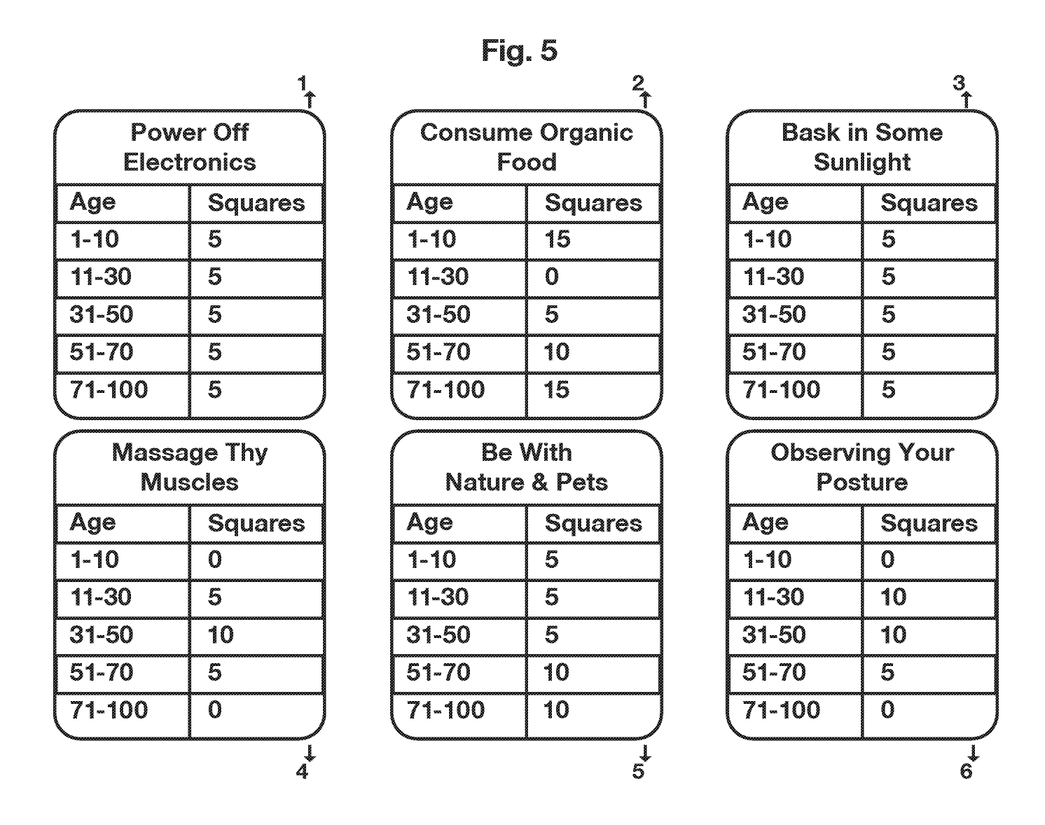

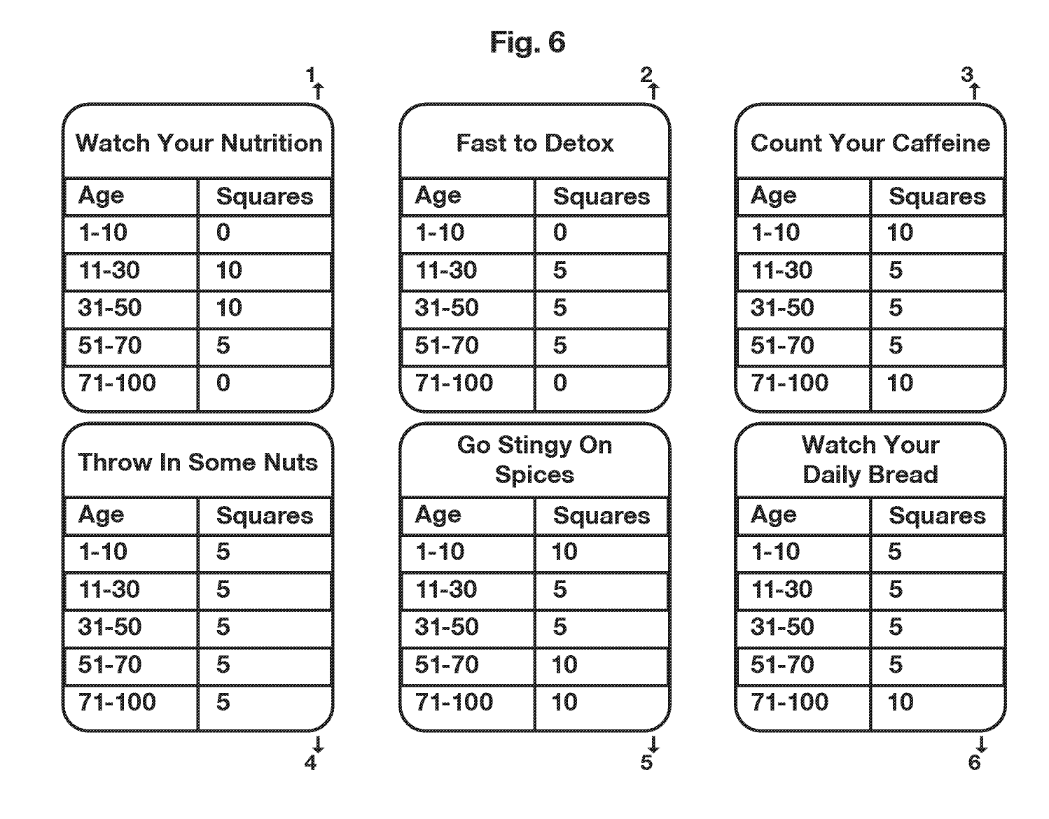

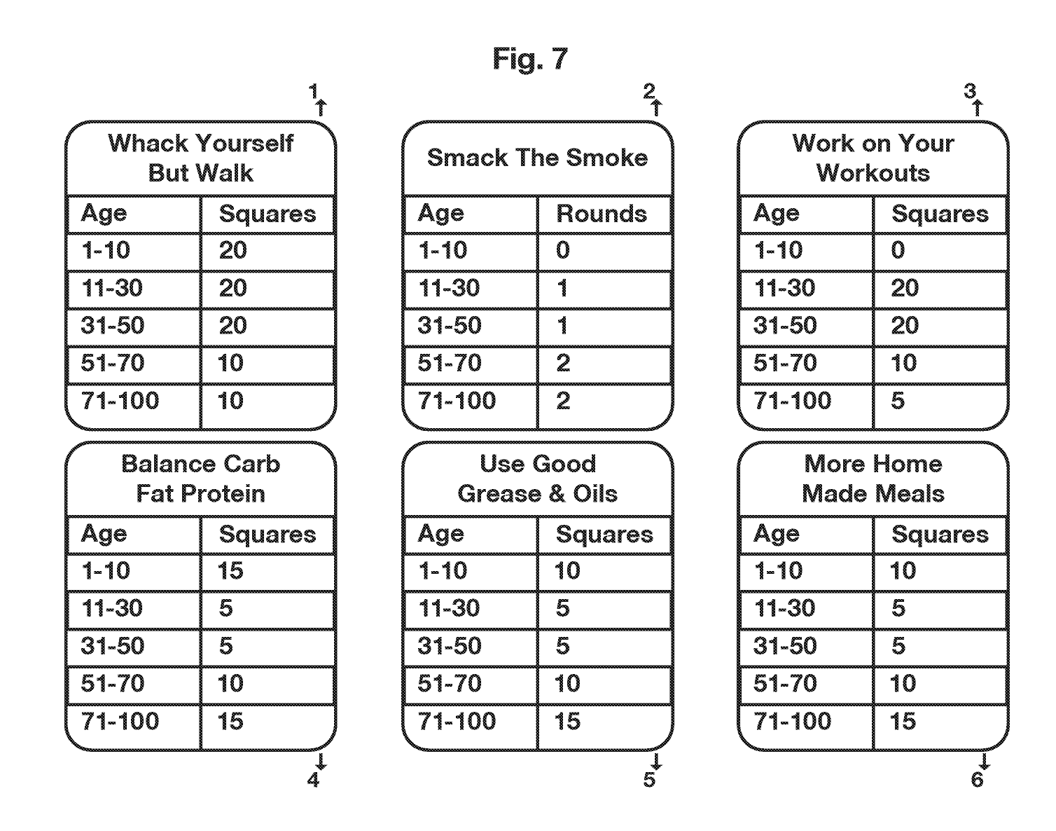

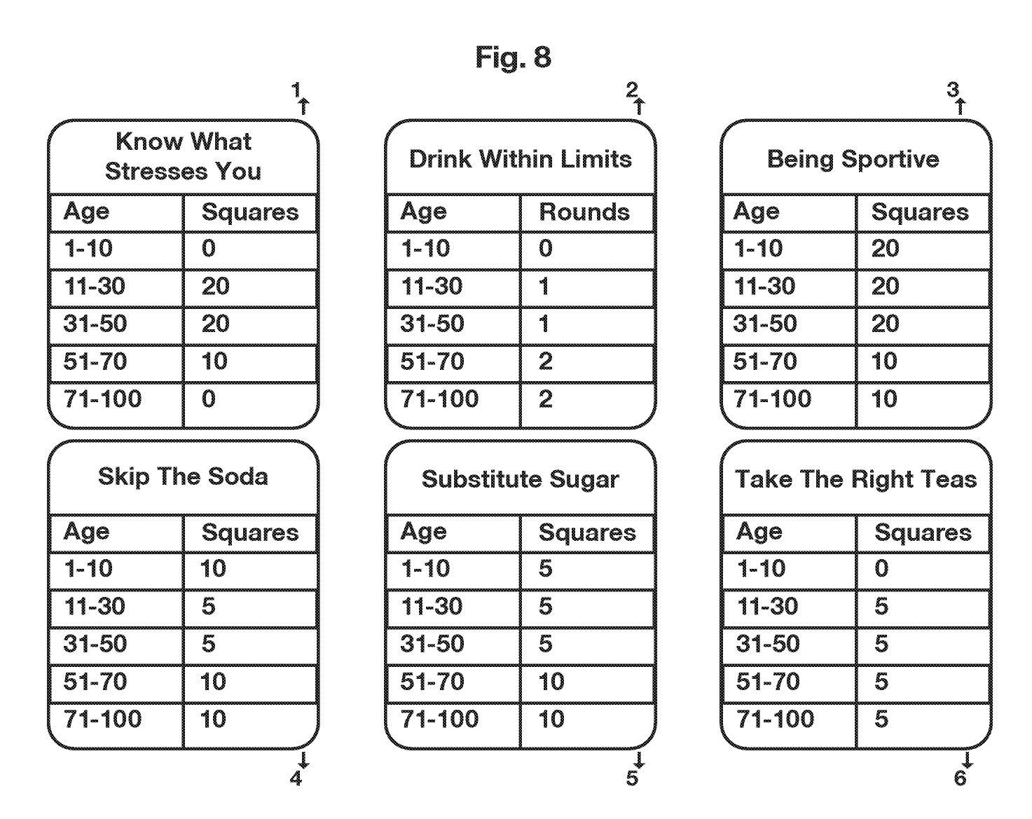

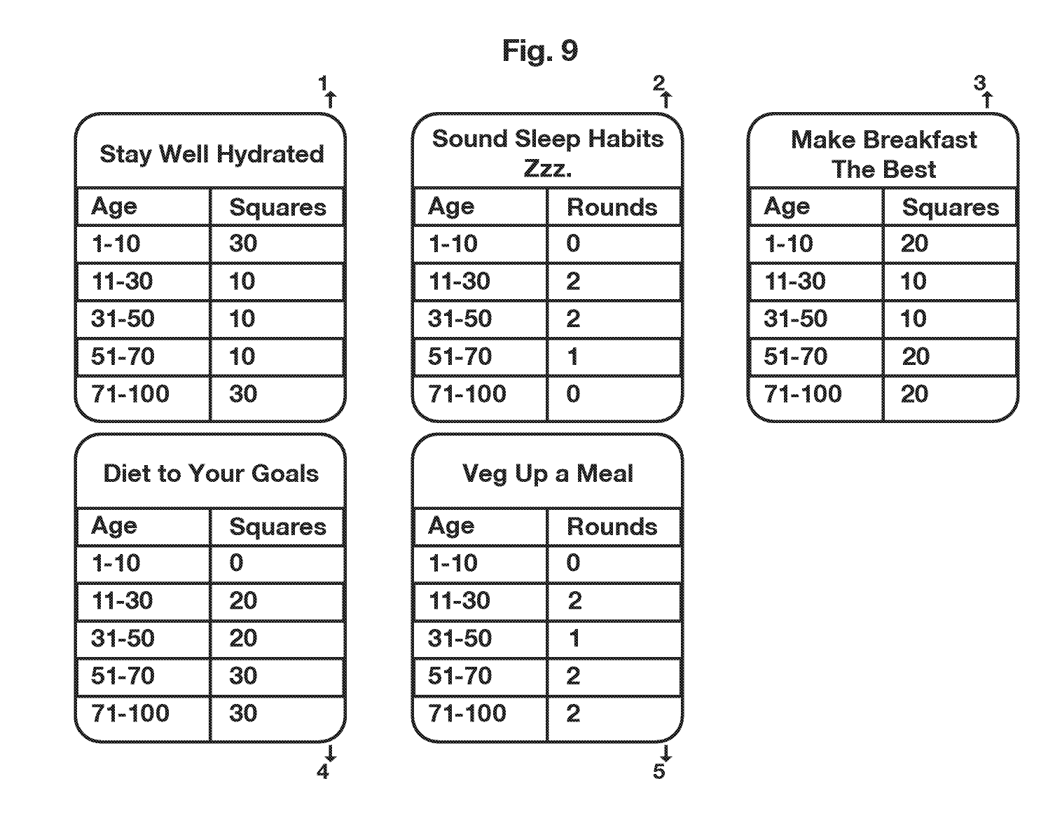

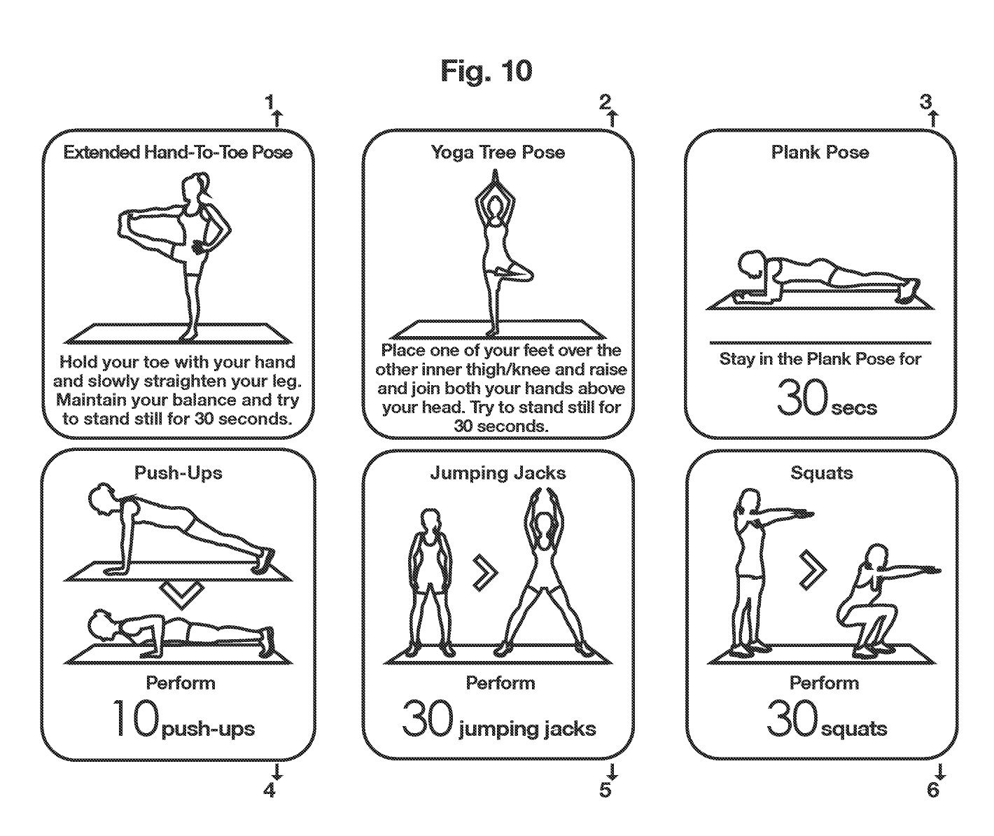

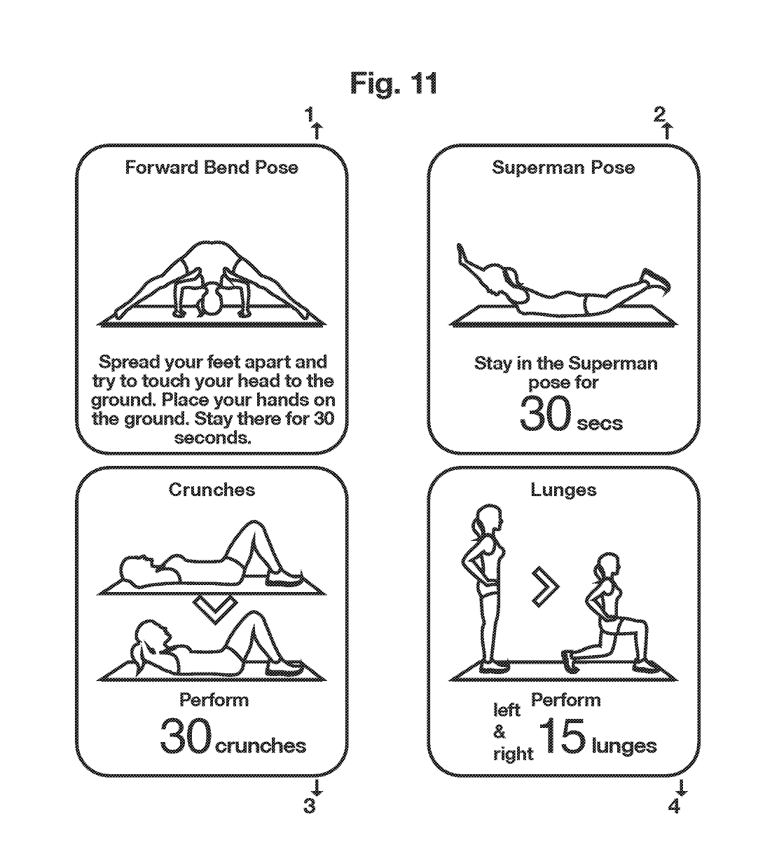

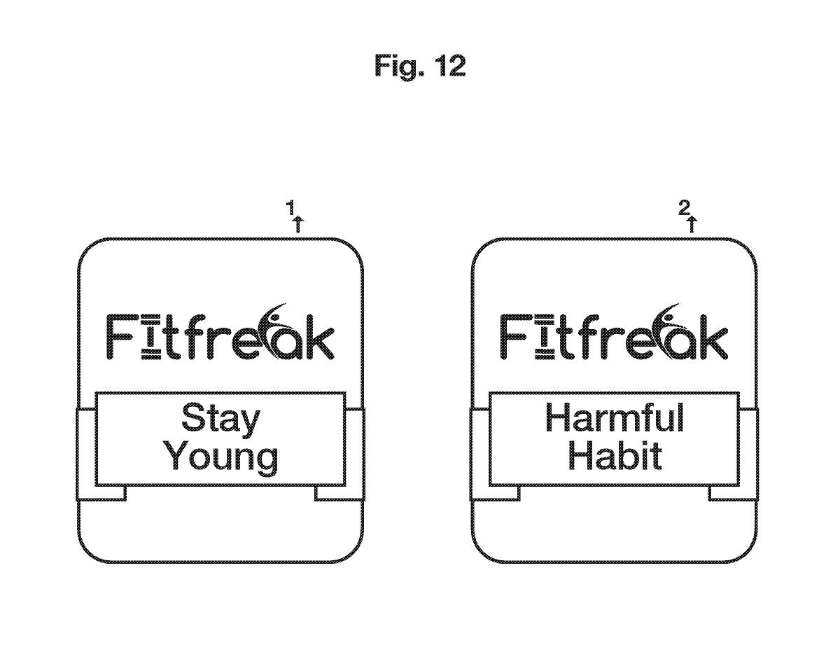

(1) The players surrounding the game board (Represented as FIG. 1) use dice (Represented as FIG. 3) and their respective player pins/pawns (Represented as FIG. 2). Each of players will take turns to roll the die (singular of dice). The player(s) that rolls 1 on the die, can place their player pins on the start square marked as 1 on FIG. 1—game board.
(2) Once the player pin of the player is placed on the start square, game play progresses with rolling the die in clockwise/anti-clockwise turns. As this pattern continues in moving the player pin in a clockwise direction on the game board and the player(s) lands on the start square (1 on FIG. 1 —Game Board) again, the player will add 10 years to their fictitious age during the game play. Hence, landing on the start square after one clockwise round will make a player 10 years old, after two clockwise rounds 20 years old and so on. The player must remember their fictitious age in the game at all times as the penalties for a harmful habit (as described ahead in this document) vary based on the players fictitious age in the game.
(3) As a general rule, landing on any square as a result of rolling 1 or 6 on the die indicates that the player does not have a positive bent with respect to the habit mentioned on the square. This negative bent towards the health habit, penalizes a player by moving forward the number of squares or rounds as specified in the Harmful Habit Cards for that particular square. This implies that a pejorative health habit advances the age of the player faster, hence leading them to finish and exit the game faster, resulting in their losing the game. The harmful habit card associated with all squares on the board penalize the player based on their fictitious age. As an example, the penalty for the same harmful health habit (not getting adequate sleep) may vary for a player with fictitious age 20 and one with fictitious age 80 in the game. This is described in adequate detail and clarity, on each harmful habit card. In other words, each square has a harmful habit card associated with it. The stack of harmful health habit cards Vis a Vis the squares is placed at 38 on FIG. 1—Game Board. All harmful habit cards related to all the squares on the game board are represented in FIGS. 4, 5, 6, 7, 8 and 9.
(4) An additional rule is that, landing on squares 5 or 15 or 23 or 33 on FIG. 1—game board, by a player as a result of rolling 1 or 6 on the die more than thrice during game play, will lead to the player having to exit the game. This rule is called as “Dead due to bad habits”.
(5) A player that lands on a square without a positive bent of the health habit, can counter the effect of the harmful habit by picking up a challenge card at random from the stack of “Stay Young Cards” placed at 37 on FIG. 1—Game Board. All Stay Young cards are represented in FIGS. 10 and 11.
(6) In all other cases, the player will merely place their player pin on the square resultant from the roll of the die, and wait for their turn to roll the die again.
(7) A player may land on a square as a result of a die roll (or) as a result of a moving forward the specified number of squares/round(s) as a result of picking up a harmful habit card from another square. The table below explains the relationship between the square on the board and the corresponding harmful habit card:

| Square # | | | Penalty (Moving |
|---|---|---|---|
| on FIG. | | | forward squares) for |
| 1- | | Pejorative Connotation of | the Harmful Habit, |
| Game | | the Health Habit/Harmful | specified on FIG. |
| Board | Corresponding Health Habit | Habit Description | and Card # |
| FIG. 1- | Laugh and Smile More and | Frowning and grumbling | FIG. 4-Harmful |
| 2 | having a generally positive | more and having a | Habit Cards-Card # |
| | attitude | generally negative | 1 |
| | | attitude. | |
| FIG. 1- | Meditate for the Mind and | Not having a practice of | FIG. 4-Harmful |
| 3 | mental peace | meditation in one's daily | Habit Cards-Card # |
| | | life | 2 |
| FIG. 1- | Limiting Toxic Intake in | Not being mindful in | FIG. 4-Harmful |
| 4 | various forms-air, food etc. | consuming excessive | Habit Cards-Card # |
| | | toxins | 3 |
| FIG. 1- | Having a Hygienic and Safe | Callous and unsafe | FIG. 4-Harmful |
| 5 | Sex Life | sexual practices | Habit Cards-Card # |
| | | | 5 |
| FIG. 1- | Intake of Regulated Medicinal | Unregulated intake of | FIG. 4-Harmful |
| 6 | Dosage as per one's needs | medicinal dosages | Habit Cards-Card # |
| | | | 4 |
| FIG. 1- | Maintaining Good Dental | Not maintaining proper | FIG. 4-Harmful |
| 7 | Hygiene | dental hygiene | Habit Cards-Card # |
| | | | 6 |
| FIG. 1- | Controlled Use of Electronic | Unregulated and | FIG. 5-Harmful |
| 8 | Equipment | uncontrolled use of | Habit Cards-Card # |
| | | electronics | 1 |
| FIG. 1- | Consumption of Organic | Excessive intake of in- | FIG. 5-Harmful |
| 9 | Food | organic and GMO foods | Habit Cards-Card # |
| | | | 2 |
| FIG. 1- | Adequate Exposure to | Not receiving adequate | FIG. 5-Harmful |
| 10 | Sunlight | exposure to sunlight | Habit Cards-Card # |
| | | | 3 |
| FIG. 1- | The general practice of | Not having the practice of | FIG. 5-Harmful |
| 11 | massages for the body | receiving massages for | Habit Cards-Card # |
| | | the board | 4 |
| FIG. 1- | Spending time in nature and | Unwillingness or inability | FIG. 5-Harmful |
| 12 | with pets | to spend time with nature | Habit Cards-Card # |
| | | and effects | 5 |
| FIG. 1- | Observing and maintaining | A general lack of | FIG. 5-Harmful |
| 13 | good posture and performing | awareness towards | Habit Cards-Card # |
| | yoga to help with the same | posture and not | 6 |
| | | performing yoga to | |
| | | improve the same | |
| FIG. 1- | Awareness of one's stressors | Being completely | FIG. 8-Harmful |
| 14 | | unaware of what stresses | Habit Cards-Card # |
| | | oneself | 1 |
| FIG. 1- | Consuming alcoholic drinks | Uncontrolled intake of | FIG. 8-Harmful |
| 15 | within one's limits | alcohol | Habit Cards-Card # |
| | | | 2 |
| FIG. 1- | Including Sports as a part of | Not including any sportive | FIG. 8-Harmful |
| 16 | one's lifestyle | activity as a part of one's | Habit Cards-Card # |
| | | lifestyle | 3 |
| FIG. 1- | Having nutritional awareness | A lack of nutritional | FIG. 6-Harmful |
| 17 | | awareness | Habit Cards-Card # |
| | | | 1 |
| FIG. 1- | Including fasting as a part of | A diet that does not | FIG. 6-Harmful |
| 18 | one's fitness regime | include fasting towards | Habit Cards-Card # |
| | | once fitness goals | 2 |
| FIG. 1- | Controlling the intake of | Uncontrolled intake of | FIG. 6-Harmful |
| 19 | caffeine | caffeine | Habit Cards-Card # |
| | | | 3 |
| FIG. 1- | Including nuts as a part of | Not consuming adequate | FIG. 6-Harmful |
| 20 | one's diet | nuts as a part of one's | Habit Cards-Card # |
| | | diet | 4 |
| FIG. 1- | Controlling one's spice intake | Uncontrolled or excessive | FIG. 6-Harmful |
| 21 | | intake of spices | Habit Cards-Card # |
| | | | 5 |
| FIG. 1- | Controlling one's bread and | Uncontrolled or excessive | FIG. 6-Harmful |
| 22 | refined flour intake | intake of bread and | Habit Cards-Card # |
| | | refined flour | 6 |
| FIG. 1- | Including walking as a part | Not including walking as a | FIG. 7-Harmful |
| 23 | one's fitness activity | part of one's fitness | Habit Cards-Card # |
| | | activity | 1- |
| FIG. 1- | Regulating one's smoking | Unregulated and | FIG. 7-Harmful |
| 24 | habit | excessive smoking habit | Habit Cards-Card # |
| | | | 2 |
| FIG. 1- | Exercising and working out | Not exercising and | FIG. 7-Harmful |
| 25 | regularly | working out regularly | Habit Cards-Card # |
| | | | 3 |
| FIG. 1- | Balancing the intake of | Lack of awareness and | FIG. 7-Harmful |
| 26 | carbohydrates, fat and | imbalanced intake of | Habit Cards-Card # |
| | protein intake as a part of | carbohydrates fat and | 4 |
| | food and diet | protein in one's diet | |
| FIG. 1- | Consuming generally healthy | Consuming unhealthy oils | FIG. 7-Harmful |
| 27 | oils as a part of one's diet | as a part of one's diet | Habit Cards-Card # |
| | | | 5 |
| FIG. 1- | Increasing the number of | Excessive intake of meals | FIG. 7-Harmful |
| 28 | meals made at home | not made at home | Habit Cards-Card # |
| | | | 6 |
| FIG. 1- | Consuming less soda | Excessive intake of soda | FIG. 8-Harmful |
| 29 | beverage | beverages | Habit Cards-Card # |
| | | | 4 |
| FIG. 1- | Consuming less sugar | Consuming excessive | FIG. 8-Harmful |
| 30 | | sugar | Habit Cards-Card # |
| | | | 5 |
| FIG. 1- | Consuming tea's and coffee's | Excessive intake of tea's | FIG. 8-Harmful |
| 31- | that are generally considered | and coffee's that are | Habit Cards-Card # |
| | healthy | considered unhealthy | 6 |
| FIG. 1- | Adequate water intake to stay | Inadequate water intake | FIG. 9-Harmful |
| 32 | hydrated | and a general state of | Habit Cards-Card # |
| | | dehydration | 1- |
| FIG. 1- | Sound sleep per one's | Not receiving enough | FIG. 9-Harmful |
| 33 | individual needs | sleep per one's needs | Habit Cards-Card # |
| | | | 2 |
| FIG. 1- | Consuming healthy breakfast | Consuming insufficient | FIG. 9-Harmful |
| 34 | in sufficient portion size per | breakfast portion size and | Habit Cards-Card # |
| | one's individual needs | having breakfast items | 3 |
| | | that are generally not | |
| | | considered healthy | |
| FIG. 1- | Following a diet suitable to | Following a diet that is | FIG. 9-Harmful |
| 35 | one's overall good health and | unsuitable to one's overall | Habit Cards-Card # |
| | futuristic health goals. | good health and futuristic | 4 |
| | | health goals | |
| FIG. 1- | Include and increase the | Not having sufficient fruits | FIG. 9-Harmful |
| 36 | quantity of vegetables and | and vegetables as a part | Habit Cards-Card # |
| | fruits in one's meal | of once daily diet | 5 |

1. A claim is made to the title of the game currently representing a board game. The same title may be used for different purposes thereon namely an electronic version of the game, a two dimensional or 3 dimensional character associate with the same.

2. A claim is made to the concept of the game which envisages advancing the players age, faster advancing age due to bad habits, ability to reverse the fast advancing age due to good habits, sudden death of the in the event of following certain rules described above.

3. A claim is made to the terms, concept and numeric specifications of harmful habit cards and challenge cards. Harmful habit cards affiliate a player to a certain age and penalize them for a harmful health habit in the event of a certain occurrence in the game. Challenge cards can help a player mitigate the adverse effects of a harmful habit card, provided the player completes the challenge mentioned successfully.

4. A claim is made to the concept depicted on the different squares of the board pertinent to a health habit. From the player's perspective—adherence to the healthy habit depicted on the square is beneficial and advances his or her age at a regular pace and the non-adherence to the healthy habit depicted, adversely impact the players in the game.
